(19) United States
(12) Patent Application Publication
(10) Pub. No.: US 2006/0086026 A1
(43) Pub. Date: Apr. 27, 2006

(54) Customizable floor mats and vertical displays

(76) Inventors: Stanley Ho, Warren, NJ (US); Jim Ashley, Rock Hill, SC (US)

Correspondence Address: FROMMER LAWRENCE & HAUG, 745 FIFTH AVENUE- 10TH FL., NEW YORK, NY, 10151, US

(21) Appl. No.: 10/976,722

(22) Filed: Oct. 27, 2004

(51) Int. Cl. G09F 7/02

(52) U.S. Cl. 40/618

(57) ABSTRACT

A floor mat or vertical display having a main section and an insert section. The main section includes a shaped space for accommodating the insert section, such that the appearance of the mat or display can be customized by selecting the insert section that is placed into the shaped space.

### FIELD OF THE INVENTION

The present invention relates to floor mats, area rugs, and vertically mounted exhibits; and more particularly to a floor mat, area rug or vertically mounted exhibit having an insert section that is incorporated into the article.

### BACKGROUND OF THE INVENTION

Various types of mats and area rugs (collectively referred to hereinafter as “floor mats”) are a common feature around homes and other types of buildings. A typical building owner will purchase a “welcome mat” for use just outside the main entrance of a building, an indoor mat for use just inside the entrance, and one or more area rugs for use in decorating and protecting open floor areas. Furthermore, the building owner will frequently purchase replacement mats when current mats wear out. This is particularly true of welcome mats, which tend to wear out faster than indoor mats and rugs since they are exposed to the elements and since people arriving at the entrance where they are placed use them to clean off their shoes prior to entering the building.

Floor mats have also been used to mark special occasions and changes of season, and to advertise products and services. For example, many homeowners will mark the Christmas holiday by using a welcome mat that depicts a Christmas scene such as a snowman or Santa Claus. Still further, some building owners have begun to employ customized floor mats, such as a welcome mat bearing the street number of the building for which it is used, or a welcome mat bearing the name of a sponsor.

Homeowners and building owners also make frequent use of flat wall mounted displays for purposes of decorating open wall areas, marking special occasions and changes of season. Owners of commercial buildings also use such displays for advertising products and services.

In view of the multiplying uses of floor mats and vertical displays, many building owners find themselves buying a large number of such articles, and find themselves frequently going through the process of storing or disposing of a currently used mats and displays and deploying different ones.

### SUMMARY OF THE INVENTION

The inventor of the present invention has noted the expanding practice of using a multiple of interchangeable floor mats and vertical displays and has recognized the desirability of providing floor mats and displays with a customizable appearance. Accordingly, the present invention provides a floor mat or vertical display having a main section and an insert section, wherein the main section includes a shaped space for accommodating the insert section, such that the appearance of the mat or display can be customized by selecting the insert section that is placed into the shaped space.

### BRIEF DESCRIPTION OF THE DRAWINGS

The following detailed description, given by way of example and not intended to limit the present invention solely thereto, will best be appreciated in conjunction with the accompanying drawings, wherein like reference numerals denote like elements and parts, in which:

FIG. 1 shows a main section and insert section in accordance with the present invention;

FIG. 2 shows the floor mat of FIG. 1 with the insert section positioned within the main section;

FIG. 3 shows the floor mat of FIG. 2 with a different insert section positioned within the main section; and

FIG. 4 shows an illustrative embodiment of a vertically mounted display in accordance with the present invention.

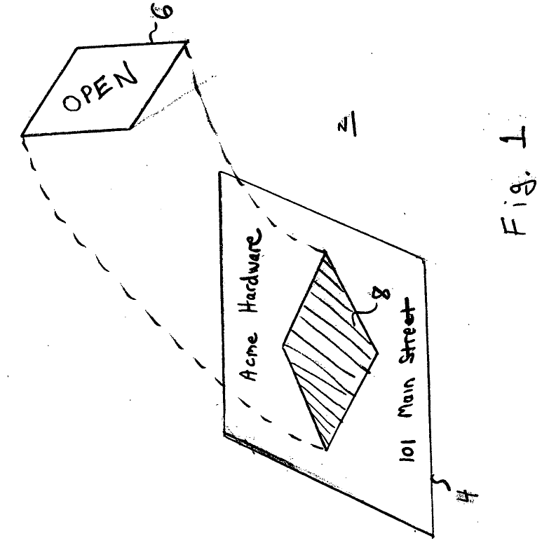

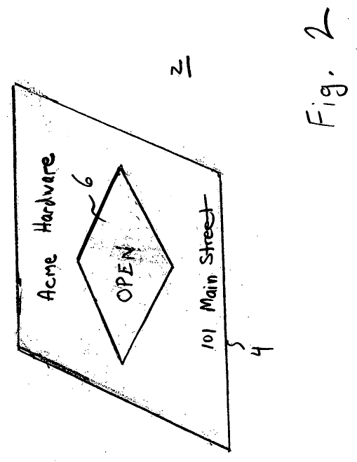

Referring to FIG. 1, there is shown a floor mat 2 in accordance with the present invention. The floor mat is made up of a main section 4 and an insert section 6. The main section includes a shaped space 8 for accommodating the insert section such that when the insert section is inserted into the shaped space the mat appears as shown in FIG. 2. The main section completely surrounds the insert section along the periphery of the insert section.

The insert section is a secured within the shaped space using any number of alternative techniques. One way to removably affix the insert section to the main section is through the use of a VELCRO fastening system. That is, a VELCRO hook section could be applied to the shaped space while a VELCRO loop section is applied to the back of the insert section such that the hook and loop sections can hold together the mat sections. An alternative is to apply a loop section to the shaped space and a hook section to the insert section.

Other ways for removably affixing the mat sections to one another include the use of a magnetic coupling and the use of a snap-fit arrangement. Still further, the insert section may be simply placed in the shaped space and held in place by nothing more than its own weight.

One way to permanently affix the mat sections to one another is through the use of an adhesive. Another way to permanently affix the sections is through a locking snap-fit.

Of course, any combination of the above techniques may be used to secure the mat sections, and additional techniques for securing the mat sections will be apparent to one skilled in the art of the invention upon reading this description.

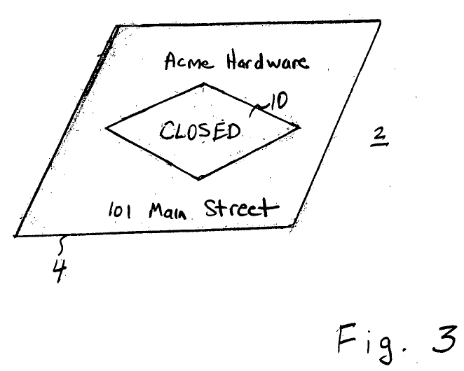

In any event, it is noted that the floor mat depicted in FIGS. 1 and 2 is designed for use at a store front and serves to indicate when the store is open for business. Accordingly, the insert section 6 is detachable affixed and bears the word “OPEN.” When the store is closed, the mat is employed as shown in FIG. 3. In FIG. 3, the insert section 6 bearing the word “OPEN” has been removed and an insert section 10 bearing the word “CLOSED” is inserted into the shaped space. In this manner the store using the mat, “Acme Hardware,” can employ a customized main section bearing its name and address, “Acme Hardware—101 Main Street,” and can insert the appropriate section to indicate when they are open or closed. Further, the insert sections are positioned at the parts of the mat that wear down quickest, allowing for a worn insert section to be replaced with a new insert section to improve the overall condition of the mat without having to replace the main section.

It is important to note that the “OPEN” and “CLOSE” messages are only examples of the messages that can be displayed using the invention. Alternative messages that may be displayed include advertising messages indicative of a particular product or slogan, seasonal messages that can be changed to correspond with the current season, and holiday messages such as Merry Christmas. Of course, the term “messages” is not limited to written messages, but rather, includes pictorial messages.

As an added feature, the floor mats of the invention may include an electronic switch and sound generation circuitry for the purpose of triggering the playing of a musical greeting or other audible signal, such as a pre-recorded voice greeting. For instance, an insert section depicting a Christmas scene my include a switch and sound generation circuitry for playing the tune “Jingle Bells.” Alternatively, a welcome mat of the invention may include a switch for triggering the door bell associated with the door where the mat is placed.

Having thus described an illustrative embodiment of the present invention, it is to be understood that the invention is not limited to particular details set forth in the above description as many apparent variations thereof are possible without departing from the spirit or scope of the present invention. For example, the main section and insert sections can bear any combination of words and/or designs, the shaped space of the main section can be of any shape, such as circular, rectangular, triangular or irregular, and there may be more than one shaped space on a main section. Also, the main section need not completely surround the insert section at the periphery of the insert section, but rather, the periphery of the insert section may make up at least part of the periphery of the assembled mat.

One particular alternative embodiment is a vertically mounted implementation of the invention. In such an embodiment an article similar to the mat depicted in FIGS. 1-3, having a main section and insert section, is mounted on a wall, or suspended from a wall or ceiling. Indeed, the invention may be implemented in a dual purpose article that can be used either as a floor mat or vertical exhibit. In any case, all of the features discussed in connection with the floor mat embodiments are applicable to the vertical exhibit embodiments.

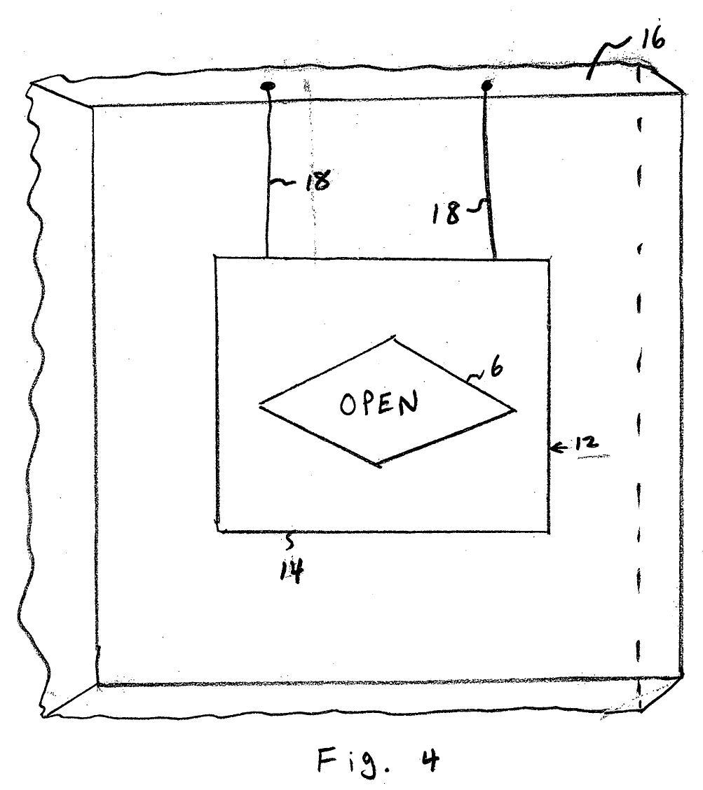

FIG. 4 shows an illustrative embodiment of a vertically mounted display in accordance with the invention. The vertical display 12 includes a main section 14 that is configured for hanging from ceiling 16 via supports 18. In this embodiment, the display uses the same insert 6 as used in the FIGS. 1 and 2 embodiments, although any of the contemplated alternative inserts may be employed.

It is to be understood that the invention defined by the appended claims is not to be limited to particular details set forth in the above description as many apparent variations thereof are possible without departing from the spirit or scope of the present invention

What is claimed is:

1. A floor mat, comprising:
a main section; and
an insert section,
wherein the main section includes a shaped space for accommodating the insert section, such that the appearance of the mat can be customized by selecting the insert section that is placed into the shaped space.

2. The floor mat as claimed in claim 1, wherein the insert section is removably affixed to the main section.

3. The floor mat as claimed in claim 1, wherein the insert section is permanently affixed to the main section.

4. The floor mat as claimed in claim 1, wherein the main section completely surrounds the insert section at the periphery of the insert section.

5. The floor mat as claimed in claim 1, wherein the main section does not completely surround the insert section at the periphery of the insert section.

6. The floor mat as claimed in claim 1, wherein the insert section includes a switch for triggering the generation of an audible signal.

7. A vertically mounted exhibit, comprising:
a main section; and
an insert section,
wherein the main section includes a shaped space for accommodating the insert section, such that the appearance of the exhibit can be customized by selecting the insert section that is placed into the shaped space.

8. The exhibit as claimed in claim 1, wherein the insert section is removably affixed to the main section.

9. The exhibit as claimed in claim 1, wherein the insert section is permanently affixed to the main section.

10. The exhibit as claimed in claim 1, wherein the main section completely surrounds the insert section at the periphery of the insert section.

11. The exhibit as claimed in claim 1, wherein the main section does not completely surround the insert section at the periphery of the insert section.

12. A method of providing messages, comprising the steps of:
providing a generally flat article having a main section and an insert section, wherein the main section includes a shaped space for accommodating the insert section and the insert section bears a message; and
changing the insert section to an insert section bearing a new message that is desired to be currently transmitted.
